(19) United States
(12) Patent Application Publication
(10) Pub. No.: US 2009/0077969 A1
(43) Pub. Date: Mar. 26, 2009

(54) Heat Transfer Methods for Ocean Thermal Energy Conversion and Desalination

(76) Inventor: Melvin L. Prueitt, Los Alamos, NM (US)

Correspondence Address: Melvin Prueitt, 161 Cascabel St., Los Alamos, NM, 87544, US

(21) Appl. No.: 11/860,647

(22) Filed: Sep. 25, 2007

(51) Int. Cl. F03G 7/05; C02F 1/16

(52) U.S. Cl. 60/641.7; 202/167

(57) ABSTRACT

A means is provided to produce fresh water from seawater on both the boiler side and the condenser side of an OTEC power plant. Part of the warm ocean surface water is evaporated, and its vapor transfers heat to the working-fluid boiler as the vapor condenses. The condensation of the vapor provides fresh water. On the condenser side, the condensation of the working-fluid vapor from the turbine in the condenser releases heat that evaporates seawater that runs down the outside of the condenser surfaces. The vapor from the seawater is condensed by a heat exchanger that uses input from colder seawater. As the cold seawater accepts heat from the condensing vapor, it becomes slightly warmer and provides the source of seawater that accepts heat from the condenser. The condensing vapor on the heat exchanger becomes fresh water that is drawn out as potable water. To provide additional fresh water, a multi-stage desalination unit uses the warm water discharge and the cold-water discharge from the OTEC plant to provide a temperature gradient that causes evaporation and condensation in each stage of the unit.

### CROSS-REFERENCE TO RELATED APPLICATION

This claims priority to and the benefit of Provisional U.S. Patent Application Ser. No. 60/827,881, filed Oct. 2, 2006, the entirety of which is hereby incorporated herein by reference.

### BACKGROUND OF THE INVENTION

OTEC (Ocean Thermal Energy Conversion) plants have been used to produce electric power and to desalinate seawater. In one method, the warm water flashes to water vapor. In an open cycle system, the water vapor can drive a turbine and then is condensed to produce fresh water. For a closed cycle, the warm water is used to boil the working fluid in a heat exchanger or by allowing the warm water to flash to vapor, which then condenses on the boiler surfaces to release the heat of condensation of the water vapor, as presented in U.S. Pat. Nos. 5,513,494 and 4,324,983. The condensed water is fresh water that can be used by nearby communities. The working fluid is normally condensed in a heat exchanger by the flow of cold water through the condenser.

It was obvious to those working in the OTEC industry that warm water could flash to vapor that would transport heat and provide fresh water upon condensation. This operation occurs on the boiler side of the heat engine. But it seems counterintuitive that cold water on the condenser side could be caused to flash to vapor, since the cold water has lower temperature than the condenser, and vapor from the cold water would not flow to the condenser. This invention provides a method of causing the cold water to evaporate and provide another source of fresh water, almost doubling the amount of desalinated water from the OTEC plant.

For additional fresh water production, this invention provides a method of using the warm-water discharge and the cold-water discharge in a desalination unit.

This invention can not only be used in an OTEC plant, but it can also be used in other power generation systems. For example, in a geothermal power generation plant, if superheated water is available from underground, it can be evaporated under pressure. The vapor would flow to a boiler, where it would condense on the boiler to boil a working fluid. The condensed water would be clean, distilled water. Throughout this description, the term “OTEC” is usually used to refer to the power plant, but it should be kept in mind that this invention can be used in other types of power plants.

### SUMMARY OF THE INVENTION

The preferred embodiment of the present invention does not flash the warm water but rather allows warm water to run down a surface and absorb heat from the incoming warm ocean water as it vaporizes. The vapor flows to the surface of a boiler where it deposits heat as it condenses. The heat boils a working fluid to drive a turbine. The condensed water runs down and is collected for potable uses. This is somewhat similar to prior art that uses the flash method of producing vapor from the warm water.

The advantages of having the water evaporate from a flowing film of water rather than flashing the water to steam is that a water droplet collection system is not needed, and since there is no splashing of flashed water droplets, the formation of mineral scale is eliminated.

Rather than having a pre-deaerator to remove dissolved air in the incoming water, this system prevents the buildup of the air entrapped in the vapor flow and removes the air continually from the system.

Previous designs of OTEC plants with desalination used the warm water to produce the desalinated water on the boiler side of the system, but the cold side of the rankine cycle engine was not used for water production. In the present invention, the cold side also produces fresh water. The condensation of the working fluid in the condenser provides heat to vaporize the water, and the water vapor condenses on the surface of a cold-water heat exchanger. It is then collected for potable uses.

The entrapped air in the cold-water side of the system is treated like that of the warm-water side.

It is therefore an object of the present invention to provide a method of transferring heat from warm ocean water to the boiler of an OTEC plant using water vapor as the heat transfer medium and doing it in such a manner that water droplet collection systems are not needed and mineral scale buildup is eliminated.

It is another object of the present invention to collect the heat transfer medium, water, which condenses on the boiler, for potable uses.

It is another object of the present invention to use water vapor as a heat transfer medium to transfer heat from the working fluid condenser to cold seawater and to condense the water vapor and collect it for potable uses.

It is another object of the present invention to provide a means of removing the entrapped air in the water vapor so that it does not retard the condensation of the water vapor.

It is another object of the present invention to utilize the discharged warm water and discharged cold water to provide additional freshwater in a desalination unit.

It is another object of the present invention to provide heat transfer to a boiler and heat transfer from a condenser while producing desalinated water on the boiler side and condenser side of systems other than OTEC, such as geothermal power producers.

Other objects, advantages and novel features, and further scope of applicability of the present invention will be set forth in part in the detailed description to follow, taken in conjunction with the accompanying drawings, and in part will become apparent to those skilled in the art upon examination of the following, or may be learned by practice of the invention. The objects and advantages of the invention may be realized and attained by means of the instrumentalities and combinations particularly pointed out in the appended claims.

### BRIEF DESCRIPTION OF THE DRAWINGS

The accompanying drawings, which are incorporated into and form a part of the specification, illustrate embodiments of the present invention and, together with the description, serve to explain the principles of the invention. The drawings are only for the purpose of illustrating preferred embodiments of the invention and are not to be construed as limiting the invention. In the drawings:

FIG. 1 is a schematic cross section for a system that produces fresh water from the warm-water side of an OTEC plant as it transfers heat from the warm ocean water to the boiler, and produces fresh water from the cold-water side of an OTEC plant as it transfers heat from the condenser to the cold seawater.

FIG. 2 is a schematic cross section end-view of one design of the cold-water side of an OTEC plant showing a condenser pipe containing a number of working-fluid condenser tubes where cold seawater is evaporated from the outside of the tubes and a heat exchanger pipe in which the water vapor condenses as it transfers heat to incoming cold water.

FIG. 3 is a schematic cross section side view of one design of the warm-water side of an OTEC plant showing a number of slanted parallel plates on which warm ocean water flows down as a film and evaporates as it picks up heat from warm ocean water that flows below the slanted surface, and the warm vapor flows to a boiler (not shown) to provide heat to boil a working fluid.

FIG. 4 is a schematic of a multi-stage desalination system that uses warm-water discharge and cold-water discharge from the OTEC plant of FIG. 1.

### DETAILED DESCRIPTION OF THE INVENTION

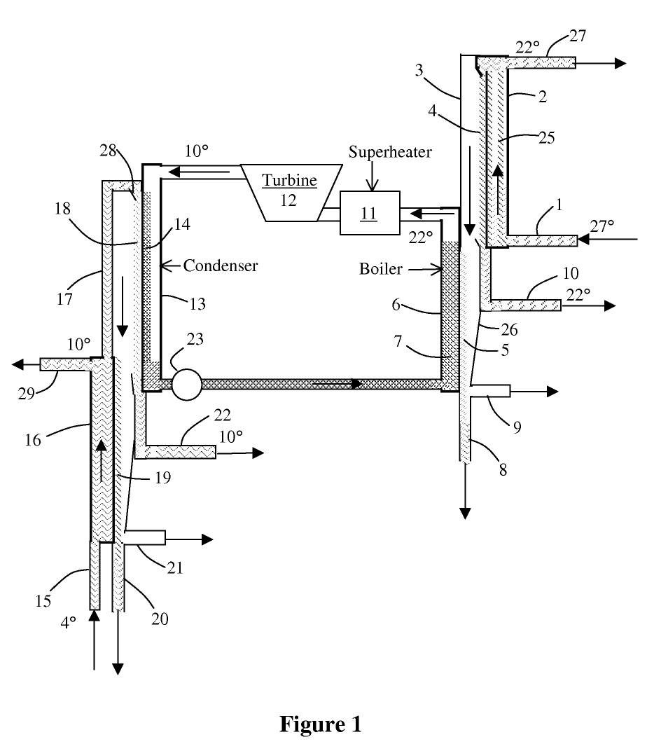

FIG. 1 shows schematically an embodiment of the present invention of an OTEC plant that uses water vapor as the heat transfer medium to move heat from the warm ocean water to the working fluid vapor, and uses water vapor as a heat transfer medium to transport heat from the condenser to the cold ocean water. It also shows the collection of fresh water from the warm and cold sides of the OTEC plant.

As the warm ocean water enters through pipe 1 to a heat exchanger 2, it provides heat through a heat exchanger wall to a film of seawater 4 that is flowing down the other side of the wall in an evacuated chamber 3. The warm water cools as it flows upward through the heat exchanger channel 25, because it is releasing heat to the water film 4. When it gets to the top of the channel 25, part of it then flows down as a film of water 4 on the right wall of the evacuated chamber 3. The rest of the water flows out the discharge pipe 27. Since the water flowing down as a film 4 has a temperature near equilibrium with the water vapor in chamber 3, it does not flash. It absorbs heat as it evaporates at constant temperature. The seawater from the flowing film flows out the warm-water discharge pipe 10.

Heat exchanger 2 should be tall enough so that the pressure created by the column of water will prevent the warm water at the bottom of channel 25 from flashing. It would be appropriate to have the whole unit high enough above the ocean surface so that the pressure is low in the water.

The water vapor flows down in chamber 3 and condenses as a fresh-water film 5 on the wall of the boiler 6, which contains a low-boiling-point working fluid 7. The vapor channel 26 beside the boiler 6 is designed so that the vapor flows continuously downward as the channel becomes narrower. That keeps the vapor flowing downward, and it carries any entrapped air that was previously dissolved in the water down to the bottom of the channel. As water vapor moves toward the boiler wall, the entrapped air tends to collect next to the film of condensed water 5. Since the water film 5 is flowing downward by gravity, it tends to drag the air with it. A bleed pipe 9 allows the air (along with some water vapor) to be drawn off to a vacuum pump. This is the method of deaeration of the water.

Most of the warm water is removed by pipe 27, and since it does not enter the evacuated chamber 3, it does not have to be deaerated. Previous OTEC inventions that used the flash method to transfer heat to the boiler and produce fresh water required that all the warm water had to be deaerated.

The condensed water 5, which is distilled water, flows out the fresh water outlet pipe 8 for potable uses.

The advantage of using the water vapor as a heat transfer medium is that the condensing water surface 5 is almost the same temperature as the evaporating surface 4. It is similar to a heat pipe, which is a far better heat conductor than any metal. If a regular heat exchanger is used to transfer the energy of the water to the working fluid, there is a larger temperature differential between the water and the working fluid, because the water is a poor heat conductor. Another advantage of using water vapor as the heat transfer medium, rather than using an ordinary heat exchanger is the seawater does not touch the boiler and provide corrosion and scaling problems on the boiler.

The heat supplied by the condensing water 5 boils the working fluid 7. The working fluid vapor then flows to a superheater 11 (if any) and then to a turbine 12, which extracts mechanical energy. Heat for the superheater can be supplied by solar energy, bio-fuel, fossil fuel, and/or a separate stream of warm ocean water. When the vapor leaves the turbine, it is cold. It flows to the condenser 13, where it condenses as a liquid film 14 on a wall that is cooled by the evaporation of a cold-water film 18 on the opposite side of the wall. The condensed working fluid 14 flows down to the bottom and is pumped by pump 23 back to the boiler 6 to repeat the cycle. The water film 18 flows down and is discharged through the cold-water discharge pipe 22.

Again, as with the boiler, heat is transferred by vapor in the condenser. The working fluid vapor deposits the heat in the condenser wall, and the water evaporates to remove the heat. The rolling films of the working fluid liquid 14 and the water 18 provide excellent heat transfer.

The water vapor that leaves the cold-water film 18 flows down to the cold-water heat exchanger 16. It condenses on the wall of the heat exchanger as fresh water film 19 and then flows down to the fresh water outlet pipe 20. Entrapped air in the vapor is carried down and is drawn off to a vacuum pump through pipe 21. This provides a deaeration system similar to that of the warm water side.

Note that cold seawater entering through pipe 15 into the heat exchanger 16 warms up as it flows upward through the heat exchanger, because it is receiving heat from the condensing water 19. That heat was derived from the working fluid as it condensed on as film 14 and transmitted the heat to water film 18. By the time the water in heat exchanger 16 reaches the top of the heat exchanger, it is ideally at the same temperature as film 18. (In actuality, the water will be slightly cooler than the condensing working fluid 14 in order to provide the temperature differential to cause heat flow out of the condenser). A small part of the water flowing up through heat exchanger 16 flows up to the water distributor 28, which spreads the water out as a film 18 to flow down the wall of the condenser. The rest of the water flowing up through 16 is discharged through pipe 29.

The temperatures listed on the drawing are hypothetical temperatures on the Celsius scale. They are theoretical temperatures. In a real system, they would be slightly different, due to inefficiencies in the heat exchange surfaces.

This system provides a method of producing fresh water on both the warm-water side and the cold-water side. The water vapor is also used as a heat transfer medium to move the heat from the warm water to the boiler and the heat from the condenser to the cold water heat exchanger.

At startup, after the plant has been idle, the warm water and the cold water should start flowing first so that the water films are formed. The cold-water film 18 on the condenser will cause condensation of the working fluid vapor and cause vapor to flow from the boiler 6 through the turbine 12 and to the condenser 13. That will start to cool the boiler 6, and water will start to evaporate from the warm-water film 4 and condense on the boiler.

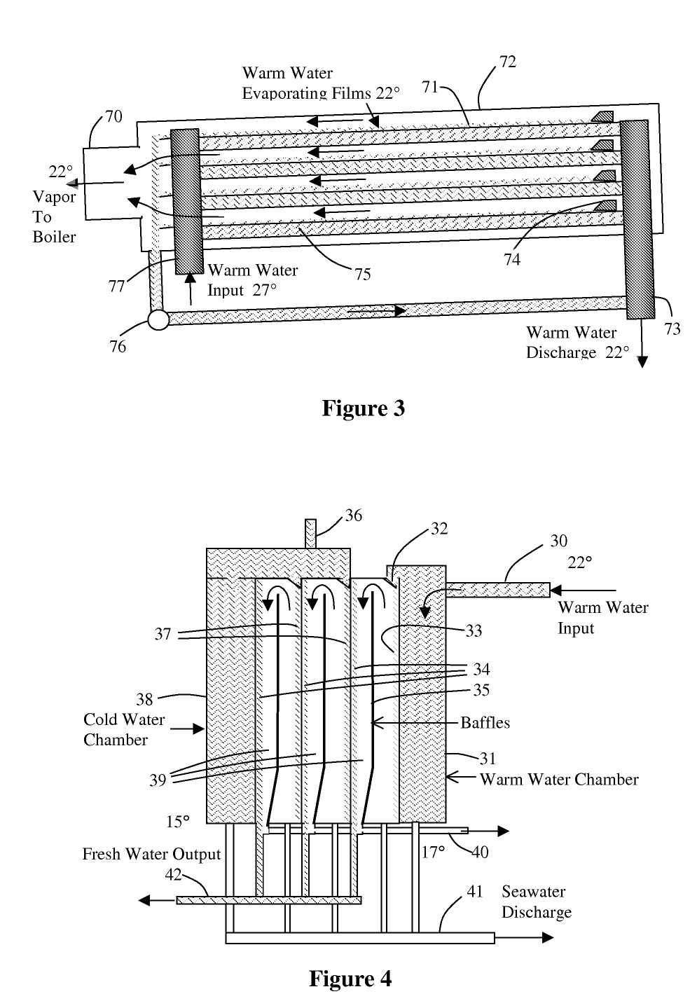

Instead of having vertical surfaces for the evaporating films, sloping surfaces or even horizontal surfaces could be used. See FIG. 3. Having the water flowing as a film provides good heat transfer. Another embodiment of the present invention would have an open container in which the warm water is allowed to flash, and the resulting vapor would flow to the boiler. That produces water droplets that are carried along with the vapor. Splash guards would be necessary. The water droplets that strike surfaces tend to build up mineral deposits, whereas water flowing in a film evaporates from the surface of the film where there is no metal surface for the minerals to deposit on. To use the flash method on the condenser side, the cold water would need to be placed on surfaces that are connected to the condenser. The water and vapor would warm up as they absorb heat from the condenser so that the vapor pressure would be sufficient to flow to the surface of heat exchanger that has incoming cold seawater.

Another embodiment of the present invention would have sprayers that spray water onto the surfaces that produce evaporation. The water droplets would tend to flash as they move toward the surfaces, and they would flash more after striking the surfaces.

FIG. 1 shows simple surfaces, but in actuality they would be multi-plate heat exchangers with films flowing down in alternate chambers while warm water flows up the other channels. Another way would be to have vertical pipes that the warm water flows up through and then part of it flows back down as a film on the outside. The evaporated vapor from the film could then flow to the outside of a boiler pipe and condense there as the working fluid boils inside the pipe.

For the working fluid condenser, the working fluid could condense inside vertical pipes while cold water flows down the outside. Vapor from the cold water could flow to the outside of cold-water pipes and condense there.

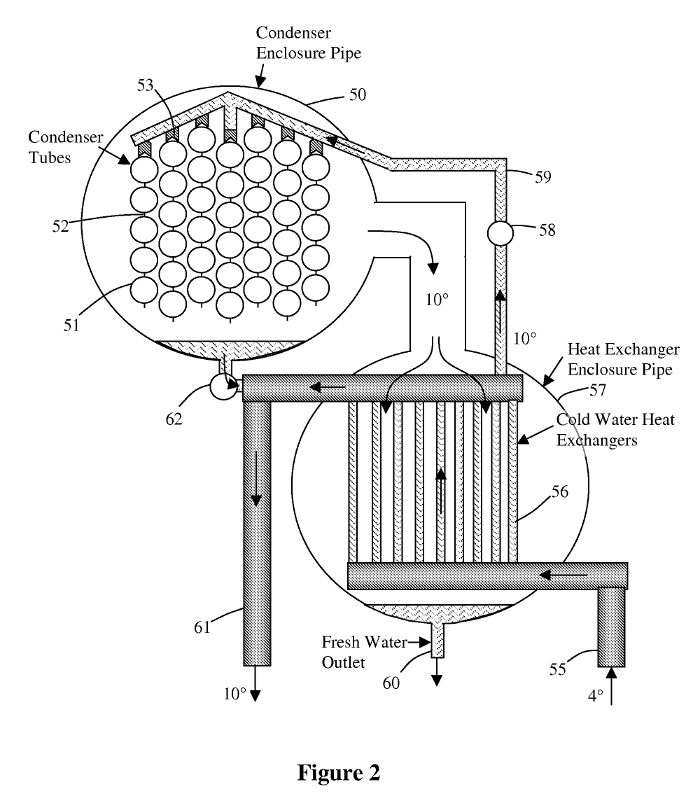

FIG. 2 shows one embodiment of the present invention that describes the flow of water and water vapor on the cold side of the OTEC plant. It shows an end view of the condenser enclosure pipe 50 and the heat exchanger enclosure pipe 57. After the working fluid vapor leaves the turbine, it flows into condenser tubes 51, which are shown in end view in FIG. 2. Cold seawater flowing down the outside the condenser tubes 51 absorbs heat from the condenser tubes and evaporates. This removal of heat causes the working fluid vapor to condense inside the condenser tubes. The working fluid liquid is then pumped back to the boiler. The connecting pipes and pump for the working fluid liquid are not shown.

The water flowing down the outside of the condenser tubes 52 that does not evaporate drips down to the bottom of the condenser enclosure pipe 50 and is pumped by pump 62 into the discharge pipe 61.

Cold seawater enters pipe 55 and flows up through cold-water heat exchangers 56. These can be tubes or chambers with rectangular cross-section that are formed by flat plates on all four sides. Water vapor that evaporates from the condenser tubes 52 in the condenser enclosure pipe 50 flows into the heat exchanger enclosure pipe 57 and condenses on the cold-water heat exchangers 56. The condensed water drips down to the bottom of the heat exchanger pipe 57 and flows out pipe 60 as fresh water.

As the cold seawater flows up through the cold-water heat exchangers 56, it becomes warmer by absorbing heat from the condensing water on the outside surfaces of the cold water heat exchangers. Most of the up flowing water flows out the discharge pipe 61, but some of the water flows through regulator valve 58, through pipe 59, and through water distributors 53, which distribute the water along the top condenser tubes. After the water runs around the top condenser tubes, it flows down to the next lower condenser tubes, etc. Metal strips 52 between the condenser tubes help to provide even flow of the water from tube to tube.

Instead of being horizontal as shown in FIG. 2, the condenser tubes 51 could be vertical, and the water could start at the top of each tube and flow as a film down each tube.

The temperatures shown at various points of the device represent ideal water temperatures in degrees C. as an example of one set of conditions. Their purpose is help the reader understand what is happening.

FIG. 3 is a schematic diagram of one arrangement of the heat and vapor transfer mechanism on the warm side of the OTEC power plant. Warm seawater enters pipe 77 and is distributed into warm water channels 75 and flows to the right. Most of this water is collected and discharged through discharge pipe 73. A small amount of the water flowing in the channels 75 passes through water distributors 74 and then flows as a film 71 down the sloping upper surfaces of the channels 75. As the water films 71 flow down, part of it evaporates as it absorbs heat from the water flowing in channels 75. The water flowing to the right in channels 75 becomes cooler as it releases heat to the water film 71. The water vapor that evaporates from the films 71 flows out pipe 70 and flows to the working fluid boiler where it condenses and releases the heat of condensation into the boiler. The water flowing in the water films 71 that does not evaporate falls to the bottom of container 72 and is pumped by pump 76 to the discharge pipe 73.

Again, the listed temperatures in degrees C. are ideal temperatures for one example of possible conditions.

The warm-water discharge is at 22° C. in the example of FIG. 1, while the cold-water discharge is at 10° C. This temperature differential can be used to produce more fresh water. FIG. 4 shows one example of a multi-stage desalination unit that can do that.

In FIG. 4, the warm-water discharge from the OTEC plant flows through pipe 30 into and through the warm seawater chamber 31, and some of it flows through water distributor 32 and flows as a water film 33 down the wall of the next chamber 39 to the left. The cold-water discharge from the OTEC plant flows through pipe 36 into and through the cold-water chamber 38 and flows as water films 37 down the right wall of some of the evacuated chambers 39. Heat from the warm seawater evaporates water from the film 33 flowing down the wall next to the warm seawater chamber. That water vapor passes around the baffle 35 and condenses on the left wall of its chamber 39 and passes heat to the flowing water film 37 through the wall. This process continues through each stage until the heat flows into the cold-water chamber 38. Each chamber from right to left is cooler than the chamber to its right.

If the vapor were to flow from the evaporating film of flowing water directly across the chamber to condense on the left wall of each chamber, it would carry the entrapped air along with it. The air would “stack up” against the water film that is flowing down the left wall, and the air layer would impede the condensation of the vapor. By placing a baffle in the middle of the chamber, the entrapped air is carried with the water vapor downward on the left side of the baffle 35 to the bottom of the chamber. The downward flow of the water film 34 also helps to move the air downward. When the air gets to the bottom, it flows out next to the water stream 34. The air is drawn off (along with some water vapor) through pipe 40 to a vacuum pump.

The seawater is discharged through pipe 41, while fresh water flows out pipe 42.

FIG. 4 shows three evacuated chambers, which represents three stages of the desalination unit, but there can be more or fewer evacuated chambers, depending on the available temperature difference between the warm water and cold-water input temperatures.

What is claimed is:

1. A power and fresh water generating system, comprising:
a source of warm water for supplying heat; and
a source of cold water as a heat sink; and
a first heat exchanger for cooling said warm water as it provides heat to an evaporating flowing film of warm water on the outside surfaces of the first heat exchanger to provide water vapor; and
a channel for conducting the water vapor to a heat-exchange surface of a working-fluid boiler; and
a pipe for conducting the working-fluid vapor from the boiler to a turbine, which extracts mechanical energy from the working-fluid vapor; and
a condenser that receives the working-fluid vapor exhaust from the turbine and condenses the working fluid to a liquid on inside surfaces of the condenser; and
a pump to pump the working-fluid liquid back to the boiler; and
a second heat exchanger for condensing water vapor on its outside surfaces as the condensation heat slightly warms said cold water that flows inside the second heat exchanger; and
a channel for conducting the slightly-warmed cold water from the second heat exchanger to outside surfaces of the condenser where the water flows down the outside surfaces of the condenser to extract heat from the condensing working fluid as the heat evaporates the water, which water vapor flows to the second heat exchanger where it condenses and slightly warms said cold water;
wherein said warm water is slightly cooled by the evaporation of a film of warm water flowing on the outside of the first heat exchanger, which film of warm water is provided by a portion of the slightly-cooled warm water, and wherein the vapor from the flowing film of water transfers heat to the boiler to boil the working fluid as the water vapor condenses on the boiler and is drawn off as potable water, and wherein the working fluid vapor flows to the turbine and then flows to the condenser where it condenses on inside surfaces of the condenser and flows down to the pump to be pumped back to the boiler, and wherein cold water is slightly warmed in the second heat exchanger and the slightly-warmed cold water flows to the outside surfaces of the condenser and flows down those surfaces as water films, and the cold-water films absorb heat from the condensing working fluid in the condenser, and wherein the absorbed heat by the water films produce water vapor that flows back to the second heat exchanger and condenses as it warms the cold water, and the condensing water vapor runs down and is drawn off as potable water.

2. A power and fresh water generating system according to claim 1, wherein the flow of water vapor from the first heat exchanger into channels in the boiler is directed in such a manner as to sweep entrapped air to the ends of the channels where the entrapped air is pumped out by a vacuum pump.

3. A power and fresh water generating system according to claim 1, wherein the flow of water vapor from the outside condenser surfaces into channels in the second heat exchanger is directed in such a manner as to sweep entrapped air to the ends of the channels where it is pumped out by a vacuum pump.

4. A power and fresh water generating system according to claim 1, wherein a superheater is provided between the boiler and the turbine to superheat the working-fluid vapor as it flows from the boiler to the turbine, which superheater may be supplied heat by warm water or other heat source.

5. A power and fresh water generating system according to claim 1, wherein the water film evaporation methods are replaced by flash evaporation methods.

6. A power and fresh water generating system according to claim 1, wherein the water film evaporation methods are replaced by water spray evaporation methods.

7. A desalination system that accepts the warm-saline-water discharge and the cold-saline-water discharge from a power plant similar to that described in claim 1 to produce potable water, comprising:
a warm-saline-water intake into a warm-water chamber where the warm saline water cools as it flows down through the warm-water chamber as it releases heat to evaporate water from a flowing film of saline water down the wall in an adjacent evacuated chamber; and
a cold-saline-water intake into a cold-water chamber where the cold saline water is heated as it absorbs heat from the condensation of water vapor on the wall of an adjacent chamber; and
a series of evacuated chambers between the warm-water chamber and the cold-water chamber; and
a distributor of saline water at the top of each of the evacuated chambers to provide films of saline water to flow down the chamber walls;
wherein the heat from the warm-water chamber flows through the wall of the chamber to heat the saline-water film flowing down the wall of the adjacent evacuated chamber, and wherein some of the saline-water film evaporates, and the vapor flows to the opposite wall of the chamber and condenses to form potable water and deposits heat in the wall, which heat flows through the wall to cause partial evaporation of the film of slaine-water flowing down the wall of the next chamber, and wherein the process is repeated through all the evacuated chambers until the last evacuated chamber, where the vapor condenses on the wall of the cold-water chamber, and wherein the saline water in each chamber flows down to the bottom of the chamber and flows out to the saline-water discharge, and the fresh water flows down to the bottom and is collected as potable water.

8. A desalination system according to claim 7, wherein baffles are placed in each evacuated chamber to force the water vapor along with its entrapped air to flow up to near the top of the chamber so that it will flow downward along the condensing surface in order to sweep the entrapped air to the bottom of the chamber where it is drawn off by a vacuum pump.
